(19) United States
(12) Patent Application Publication
(10) Pub. No.: US 2007/0191081 A1
(43) Pub. Date: Aug. 16, 2007

(54) Baling Apparatus

(76) Inventor: Graham Michael Shields, Western Australia (AU)

Correspondence Address: STURM & FIX LLP, 206 SIXTH AVENUE, SUITE 1213, DES MOINES, IA, 50309-4076, US

(21) Appl. No.: 11/537,783

(22) Filed: Oct. 2, 2006

Related U.S. Application Data
(62) Division of application No. 10/871,842, filed on Jun. 18, 2004, now abandoned.

(30) Foreign Application Priority Data
Dec. 18, 2001 (AU) 9605

(51) Int. Cl. A01D 17/02

(52) U.S. Cl. 460/114

(57) ABSTRACT

A conveying means adapted to provide a link between a combine harvester and a processing apparatus which is towed from the combine harvester, said conveying means being supported between the combine harvester and processing apparatus, said conveying means having an inlet positioned to receive trash flowing from the trash outlet of the combine harvester and an outlet positioned to deliver trash to the processing apparatus, the conveying means including a conveyor extending between the inlet and outlet to convey the trash from the inlet to the outlet.

### CROSS REFERENCE TO RELATED APPLICATION

This application is a Divisional of U.S. application Ser. No. 10/871,842 filed Jun. 18, 2004, which is incorporated by reference herein in its entirety.

### FIELD OF THE INVENTION

This invention relates to agricultural machinery and in particular machinery pertaining to the harvesting of a grain crop and the baling of the residue from the crop.

### BACKGROUND ART

In harvesting a grain crop it has been conventional practice to remove the crop utilising a harvesting machine such as a header (which may be otherwise known as a combine harvester) which processes the cut crop to separate the grain from the harvested material and to deposit the unwanted straw, chaff and other waste material (hereinafter referred to as trash) at the rear of the machine. Such trash is deposited onto the ground generally in a row behind the combine harvester and subsequently the material is collected from the ground utilising a baling apparatus which forms the trash material into bales which can be either used directly as stock feed or delivered to a mill for the production of processed stock feed. A disadvantage with such practice relates to the loss of the trash between it being deposited onto the ground and collected by a baling apparatus which can result in a loss on an average of 30% of the residue. The main reason for the inefficiency relates to the inefficiency of the baler in picking up the trash from the ground.

In addition the trash generally includes a significant quantity of weed seeds some of which can be resistant to weedicide. Therefore to deposit the seed with the weed seeds onto the ground merely serves to compound a potential weed problem, especially given the pick-up inefficiency of the baling apparatus. Therefore it has also been common practice to deliver the trash from the combine harvester into a hopper which is trailed behind or beside the combine harvester whereby the trash is subsequently deposited at a site to be burnt or otherwise destroyed. The reason for taking this later course of action is to prevent the chemical resistant weed seeds from re-entering the environment. However this action is wasteful in that it destroys a significant amount of useful material which comprises a significant proportion of the trash and it is environmentally undesirable because of the smoke created by burning of the trash and the possible danger of a loss of control of the fire.

As an alternative to the collection of the trash and depositing it at a particular site it has also been common practice to deposit the trash onto the ground and then burn the resultant windows and remaining stubble. Not only is such a practice wasteful of a valuable resource it also is poor farming practice in that it exposes the ground to erosion during the period between the harvesting of a crop and reseeding the ground

### DISCLOSURE OF THE INVENTION

Accordingly the invention resides in an attachment adapted to provide a link between a combine harvester and a baling apparatus, the baling apparatus having an inlet disposed at the forward end of the baling apparatus and the combine harvester having a mounting capable of receiving and supporting a tow hitch of a drawbar, said combine harvester also having a trash outlet for trash material, wherein the trash material results from the separation of grain from crop collected by the combine harvester, said trash outlet being capable of delivering the trash material to the rear of the combine harvester, the attachment comprising a draw bar adapted at one end to be fixed to the forward end of the baling apparatus and a tow hitch at its other end adapted to be mounted to the mounted to be towed from the combine harvester, the interconnection between the mounting and the tow hitch providing a pivotal connection therebetween, said attachment further comprising a conveying means supported from the draw bar to extend forwardly from the forward end of the baling apparatus, the forward end of the conveying means having a trash inlet positioned to receive trash flowing from the trash outlet of the combine harvester, the rear end of the conveying means having an outlet positioned to deliver trash material to the inlet, the conveying means including a conveyor extending between the forward end and the rear end and adapted to convey the trash from the thrash inlet to the outlet.

According to a preferred feature of the invention wherein the conveying means comprises an attachment which can be removably mounted to the baling apparatus.

According to a preferred feature of the invention the pivotal connection, the trash outlet and the trash inlet are located in a generally vertical alignment.

According to a preferred feature of the invention the conveyor is driven through a hydraulic drive wherein hydraulic drive is driven from the combine harvester.

According to a preferred feature of the invention the bailing apparatus is hydraulically driven and the attachment provides an interconnection between the combine harvester and the baling apparatus to enable the bailing apparatus to be driven from the combine harvester.

The invention will be more fully understood in the light of the following description of one specific embodiment.

### BRIEF DESCRIPTION OF THE DRAWINGS

The description is made with reference to the accompanying drawings of which:

FIG. 1 is a schematic side elevation of a conveying means according to the embodiment provided between a combine harvester and baler;

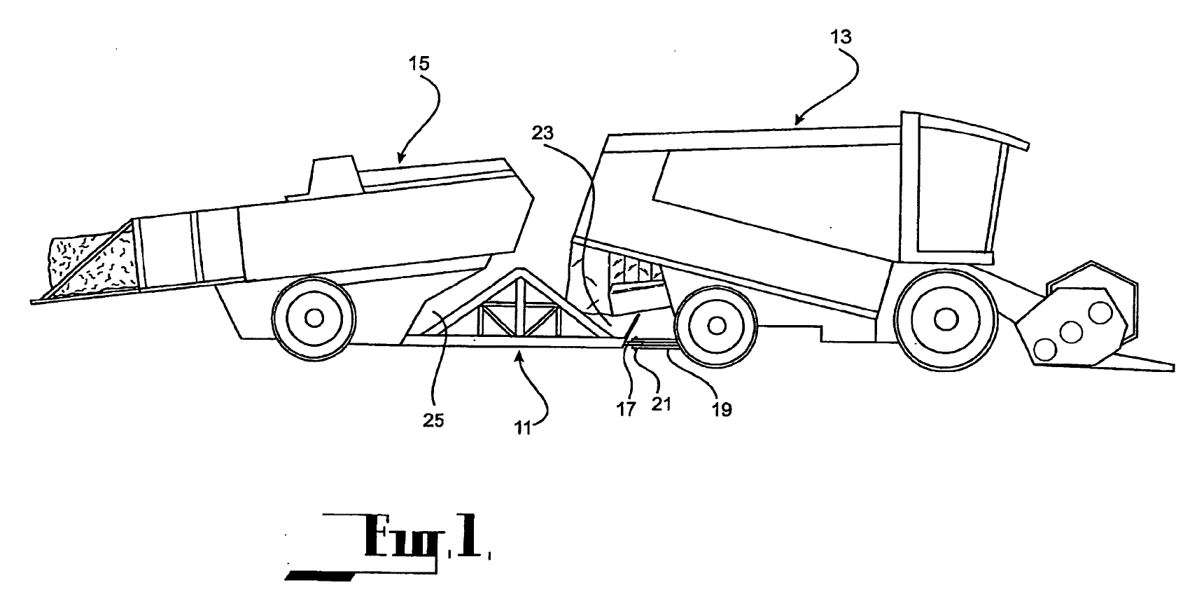

FIG. 2 is an enlarged sectional elevation of the conveying means of the embodiment in position between the combine harvester and baler which are not shown in section.

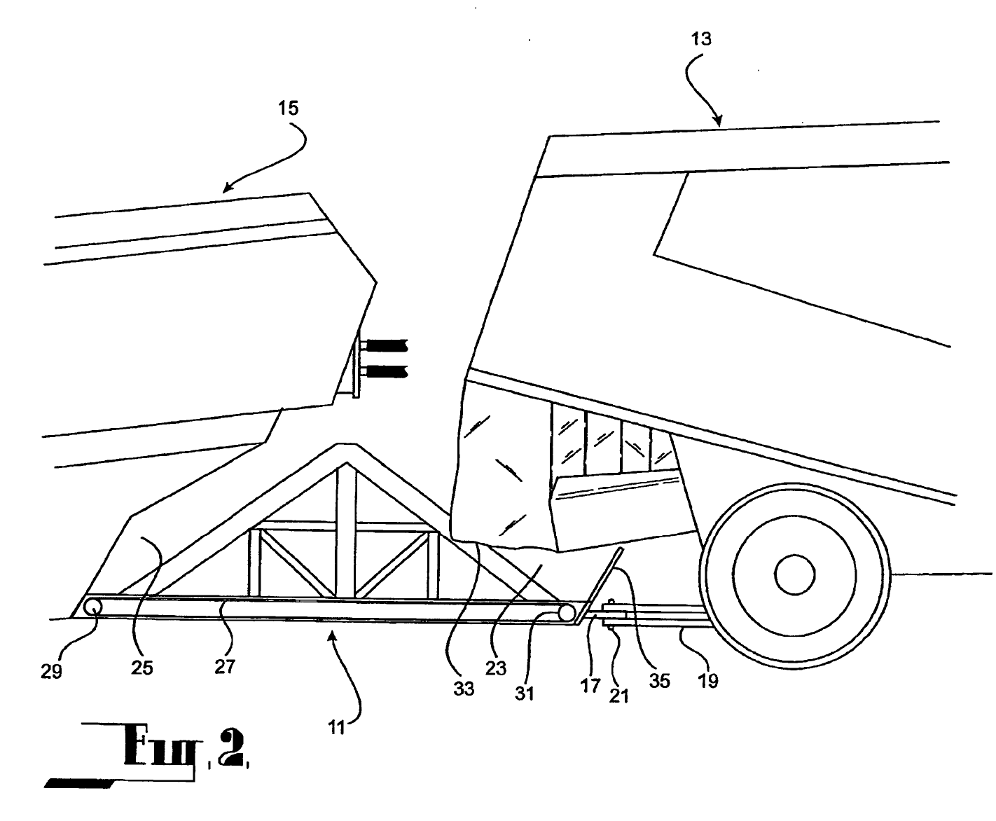

### DESCRIPTION OF SPECIFIC EMBODIMENT

The embodiment comprises a conveying means which is intended to provide a link between a combine harvester 13 and a baler 15 and which can comprise an attachment which is supported from the baling apparatus. In accordance with the embodiment the baler 15 is provided with an extended draw bar 17 which has a greater forward extent than a conventional draw bar of a baler 15. The draw bar 17 of the baler is supported from a towbar assembly 19 which is mounted to the combine harvester chassis to extend rearwardly from the combine harvester. The draw bar 17 and towbar 19 are pivotally interconnected by a pin 21 or like pivot.

The draw bar supports the conveying means 11 which comprises an inlet 23 provided at the forward most end of the draw bar 17 and an outlet 25 which is to be located at the inlet of the baler 15. A belt conveyer comprising an endless belt 27 is received over a pair of end rollers 29 and 31 which are located at the outlet and inlet end of the conveying means 11 respectively. The belt conveyer is driven by a hydraulic motor in order to convey any material which is deposited onto it at the inlet 23 to the outlet 25. The inlet 23 of the conveying means is located such that it generally underlies the outlet of the combine harvester 13 and it is provided at its forward end with an inclined forward wall 35 which is positioned in order to prevent any spillage of material flowing from the outlet 33 of the combine harvester onto the ground. As a result the positioning of the conveying means underneath the outlet substantially all of the trash being delivered from the combine harvester 15 is deposited onto the inlet 23 of the conveying means.

The outlet of the conveying means is positioned at the entry to the inlet of the baler 15 such that the trash being deposited onto the conveying means and conveyed by the belt 27 to the outlet 25 will be passed to the inlet of the baler to be baled. The forward end of the inlet 23 is located in generally vertical alignment with the pin 21 such that as the draw bar 17 of the baler 15 pivots on the pin 21, with movement of the combine harvester 13, the inlet rotates about the pivot axis of the pin 21 to pivot within the confines of the structure at the rear of the combine harvester.

The conveyor is hydraulically driven and the hydraulic drive which is utilised to drive the conveyer belt 27 over the rollers 29 and 31 is derived from the hydraulic power supply of the combine harvester. Similarly the baler is hydraulically driven and the hydraulic drive for the baler 15 is derived from the hydraulic drive accommodated within the combine harvester 13. As a result the conventional hydraulic drive of the combine harvester needs to be upgraded in order to accommodate for the increased demand required by the conveying means 11 and the baler 15.

The outlet of the combine harvester 13 is modified such that the conventional outlet chute is removed and is replaced by an outlet tray which will deposit the trash material onto the inlet 23 of the conveying means.

The embodiment provides the advantage that substantially all of the trash material produced by the processing of the harvested crop is delivered to the baler 15. As a result the inefficiencies resulting from the previous practice of initially depositing the trash onto the ground and then subsequently collecting the residual material from the ground are overcome. In addition, the event that trash material incorporates weed seeds which may be chemically resistant, all of that material is incorporated into the bales which are to be delivered to a stock food processor for the production of processed stock food which process may result in destruction of the viability of the weed seeds.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiment described above. In particular the processing unit of the invention need not be limited to a baler as described but include any other form of apparatus which is capable of processing the trash material delivered from the combine harvester. In addition the drive for the baler need not comprise a hydraulic drive and if it is hydraulically driven the drive need not be derived from the combine harvester.

1-19. (canceled)

20. Apparatus comprising:
a combine harvester, the combine harvester having a trash outlet and being disposed on ground engaging wheels, the combine harvester having a front and a rear and being capable of separating grain from trash when moving in a forward direction over ground in which a crop is grown;
a towable baling: apparatus for converting trash into compacted bales, the baling apparatus having a front end and a rear end and, an inlet adjacent the front,end for receiving trash;
a conveyor having a forward end and a rearward end, a trash inlet adjacent the forward end and, a trash outlet adjacent the rearward end;
the conveyor being operatively attached to the combine harvester such that the trash outlet of the combine is disposed above the trash inlet of the conveyor;
the conveyor being operatively attached to the baling apparatus such that the trash outlet of the conveyor is disposed adjacent the inlet of the baling apparatus; and
whereby the baler is towable behind the combine harvester so that a large percentage of the trash from the combine harvester trash outlet enters the baling apparatus inlet without ever touching the ground.

21. The apparatus as claimed in claim 20 wherein the conveyor is driven through a hydraulic drive and wherein the hydraulic drive is driven from the combine harvester.

22. The apparatus as claimed in claim 21 wherein the baling apparatus is hydraulically driven and there is an interconnection between the combine harvester and the baling apparatus to enable the baling apparatus to be drivenf from the combine harvester.

23. The apparatus as claimed in claim 20 wherein, in an operative position, the conveyor is disposed generally parallel to the ground over which the conveyor is traveling.

24. The apparatus as claimed in claim 20 wherein, in an operative position, no portion of the conveyor is disposed above the top of the baling apparatus.

25. The apparatus of claim 20 wherein at least a portion of the conveyor is configured so that the conveyor catches weed seeds to prevent such seeds from dropping to the ground.

26. The apparatus of claim 20 wherein the trash outlet of the conveyor is sufficiently close to the inlet of the baling apparatus that atmospheric winds will not blow significant amounts of trash to the ground.

27. The apparatus of claim 20 wherein the conveyor is operatively pivotally attached to the combine harvester.
